(19) United States
(12) Patent Application Publication
(10) Pub. No.: US 2020/0326486 A1
(43) Pub. Date: Oct. 15, 2020

(54) TORSION-FREE CLAMP AND FIBER CLEAVING USING SAME

(71) Applicant: 3SAE TECHNOLOGIES, INC., Franklin, TN (US)

(72) Inventors: John LOWER, Franklin, TN (US); Robert WILEY, Franklin, TN (US); Brett CLARK, Whites Creek, TN (US); Jason TROYER, Shelbyville, TN (US); Kyle SHAHAN, Nashville, TN (US)

(73) Assignee: 3SAE Technologies, Inc., Franklin, TN (US)

(21) Appl. No.: 16/304,856

(22) PCT Filed: May 30, 2017
(86) PCT No.: PCT/US2017/034973

§ 371 Date: Nov. 27, 2018

Related U.S. Application Data
(60) Provisional application No. 62/342,538, filed on May 27, 2016.

(51) Int. Cl. G02B 6/38; G02B 6/25

(52) U.S. Cl. CPC G02B 6/3861; G02B 6/25

(57) ABSTRACT

A torsion-free fiber clamp may employ a substrate in combination with an epoxy, for example, or the like, to clamp at least one fiber. The substrate may be relatively flat or it may include a groove into which the fiber is placed. The epoxy may be a relatively fast-acting adhesive. The clamp may be employed in a fiber cleaving system and operation wherein it provides a substantially torsion-free clamp of the at least one optical fiber to provide a low cleave angle.

### RELATED APPLICATIONS

The present application claims priority under 35 USC 119(e) to U.S. Provisional Patent Application Ser. No. 62/342,538, entitled “TORSION-FREE CLAMP AND FIBER CLEAVING USING SAME”, filed May 27, 2016, which is incorporated herein by reference in its entirety.

### FIELD OF INTEREST

Inventive concepts relate to the field of fiber optics, and more particularly to systems and methods for preparing and processing optical fibers.

### BACKGROUND

In conventional fiber cleavers, a first portion of a fiber is mechanically clamped by a first clamp and then a second portion of the fiber is mechanically clamped by a second clamp. Once both clamps are secured to the fiber, one clamp is selectively moved away (or translated) from the other clamp until a proper amount of tension is applied to the fiber, between the clamps.

Once the proper amount of tension is applied, a surface of the fiber is scored with, for example, an ultrasonic diamond blade. Given the tension, the scoring of the fiber surface causes a crack to propagate through the fiber, thereby cleaving the fiber.

FIG. 1 is a high level view of a conventional fiber cleaver. The cleaver is configured to cleave an optical fiber 1, at a stripped portion 2 of the fiber. The cleaver includes a fiber hold down member 3 that sits on a resting table 4. The hold down member 3 holds the un-stripped portion of the fiber.

The stripped portion of the fiber 2 is held by two clamps 5 and 6. A first portion of fiber 2 is positioned in a bottom portion 5b of clamp 5 and then a top portion 5a of clamp 5 is closed to secure the first portion of fiber 2. Fiber 2 is clamped in clamp 6 the same way. That is, a second portion of fiber 2 is positioned in a bottom portion 6b of clamp 6 and then a top portion 6a of clamp 6 is closed to secure the second portion of fiber 2. Clamp 5 can be translated away from clamp 6 to apply a controlled and accurate amount of tension to the fiber 2, between the clamps 5, 6.

Presuming the fiber is tensioned between the two clamps 5 and 6, the stripped portion of the fiber 2 between the clamps 5, 6 can be cleaved. A slider 7 includes a hard, sharp blade (e.g., an ultrasonic vibrating diamond blade) that gets placed in contact with the fiber 2 when the slider is moved in the direction of the fiber, within tracks 9. The blade 8 scores a surface of the fiber and the tension applied to the fiber causes a crack originating at the score to propagate through the fiber, resulting in a cleave.

In an ideal situation, the cleave (that is, the cleaved surface of the fiber) is perfectly perpendicular to a central axis of the fiber. However, this ideal is not practically achievable, largely because clamping with the second clamp causes a small, yet important, torsion to the fiber, which causes the propagation of the crack to be slightly off perpendicular. And, as a result, when the ends of two fibers being spliced together are not perfectly perpendicular with respect to their surfaces, the imperfect junction of the fibers adversely impacts the transmission properties of the spliced fiber.

The problem of torsion from the second clamp exists with fibers having a circular cross section. This problem is further exacerbated with fibers having other than circular cross sections and with multi-strand or bundled fibers.

U.S. Pat. No. 8,977,098 proposes an improvement over the use of two mechanical clamps. In this patent, one clamp is a mechanical clamp and the opposing clamp is made of a liquid metal. When the liquid metal is in a liquid state, a portion of the fiber can be received. Then the liquid metal is transitioned, such as through cooling to a solid state where is secures its portion of the fiber. Avoiding the use of a second mechanical clamp can significantly reduce torsion to yield an improved cleave and subsequent splice.

However, the liquid metal clamp does have certain drawbacks. The liquid metal clamp cleaver requires roughly a 2-3 minutes of cycle time, that is, the time from liquid state to clamped solid state. Also, the liquid metal has to be used with the fiber in a vertical orientation, which is not the orientation of traditional cleavers. The liquid metal is only useful for about 100 cycles/cleaves, then the liquid metal has to be replaced. For any reuse, the liquid metal must be transitioned from solid back to liquid to remove the portion of the clamped fiber to be discarded. This adds further time and energy consumption to the process with using the liquid metal clamp. The liquid metal clamp requires elements for heating and/or cooling, and associated mechanical and electrical components to support the same, so can be costly, heavier, larger, and more likely to require maintenance.

### SUMMARY

In accordance with principles of inventive concept, a torsion-free fiber clamp may include a substrate in combination with an adhesive, such as an epoxy, bonding agent, glue, or plastic resin, for example. The clamp may be referred in an “adhesive clamp” and can be used to clamp at least one fiber without torsion to the fiber, as an alternative to a mechanical clamp or a liquid metal clamp requiring heating or cooling. The substrate may be relatively flat or it may include at least one groove into which the fiber can be placed or set.

In some embodiments, the adhesive may be a fast-acting adhesive.

In some embodiments, the adhesive may have a pull strength that is greater than its peel strength.

In some embodiments, when the adhesive is cured on the substrate, the adhesive can have a pull strength to peel strength ratio of 2:1 or more.

In some embodiments, the substrate can be made of stainless steel, plastic, glass, or other material that bonds with the adhesive, but is not deteriorated by it.

In some embodiments, the adhesive is an adhesive that cures within a minute. Faster drying or curing adhesives would also be advantageous. In some embodiments, ultra-violet (UV) light can be used to promote curing of the adhesive, e.g., an epoxy.

In some embodiments, ambient temperature can be a temperature in a range of 0° C. to 100° C. In some embodiments, ambient temperature can be a temperature in a range of 15° C. to 25° C. Other temperature ranges may also suffice, so long as the temperature does not result in a materially weaker bond of the adhesive, and preferably does not extend the drying or curing time beyond about 10 minutes.

In some embodiments, the substrate is a single-use substrate. That is, in some exemplary embodiments in accordance with principles of inventive concept, an adhesive clamp may be employed for a single operation, for example, cleaving, and then discarded.

In other exemplary embodiments, the adhesive clamp may be used for one or more of a plurality of operations.

In some embodiments, a single-use clamp may employ a relatively inexpensive substrate, such as a plastic or glass substrate, and, in operation, a fiber end (also referred to herein as an “endface”) may be adhered to it then the fiber cleaved, for example. After cleaving, the substrate and fiber-end left adhering to it may be discarded.

In other exemplary embodiments in accordance with principles of inventive concept, where the substrate is a multi-use substrate that can be reused, a more substantial substrate, such as a stainless steel substrate, durable plastic substrate, and so on, may have a fiber end or intermediate portion adhered to it and, after cleaving, the fiber may be removed from the substrate in order to re-use the substrate for a subsequent operation.

In some embodiments, the fiber may be removed from the substrate by peeling the fiber and/or adhesive from the substrate.

In some embodiments, in addition to peeling or as an alternative to peeling, the fiber may be de-bonded from the substrate, using a solvent, such as acetone, for example.

In exemplary embodiments in which the substrate is re-used and the fiber end, or remainder, is peeled off the substrate, the pull-strength to peel-strength ratio of the adhesive (or epoxy) clamp may be of greater significance, because, although it is important for the fiber to remain affixed to the substrate as tension is applied to the fiber axially for a cleaving operation, it could also be considered important in some embodiments that the fiber be readily removable from the substrate, e.g., by thermal breakdown, peeling, chemical or solvent, after the cleaving operation is performed. Pull strength of the bond between the adhesive (or epoxy) and the substrate may be enhanced by forming adhesion enhancers on the substrate, either on top of the substrate in a surface-mounted implementation or within a groove in a groove-mounted implementation. Such adhesion-enhancement may take the form of cross-grooves or knurling, as examples.

In accordance with aspects of the inventive concept, provided is a fiber clamp, comprising: a substrate having an application area configured to receive a portion of at least one fiber and an adhesive applied to the application area of the substrate in a liquid state, wherein the adhesive takes a solid state when cured to form a substantially torsion-free clamp of the portion of the at least one fiber to the substrate.

In some embodiments, the adhesive is cured without heating or cooling.

In some embodiments, the substrate includes at least one adhesion enhancer.

In some embodiments, the at least one adhesion enhancer takes the form or a pattern or texture formed in the application area.

In some embodiments, the substrate includes a groove formed in the application area to receive the portion of the at least one fiber.

In some embodiments, the groove has a V-shaped cross section.

In some embodiments, the groove has a U-shaped cross section.

In some embodiments, the application area is a substantially flat surface.

In some embodiments, the substrate is a bowl.

In some embodiments, the bowl includes an opening sized for passage of the at least one fiber.

In some embodiments, the adhesive is an epoxy adhesive.

In some embodiments, the epoxy is an ultraviolet-cured epoxy.

In some embodiments, the cured adhesive exhibits a relatively high pull strength to peel strength ratio.

In some embodiments, the substrate comprises and/or is made of glass.

In some embodiments, the substrate comprises and/or is made of stainless steel.

In some embodiments, the substrate comprises and/or is made of plastic.

In some embodiments, the application area is configured to receive an end or endface of the at least one fiber.

In some embodiments, the application area is configured to receive an intermediate portion of the at least one fiber.

In some embodiments, the substantially adhesive clamp is a torsion-free, substantially uniform force clamp.

In accordance with another aspect of the inventive concept, provided is a fiber cleaver system with an adhesive clamp. The system comprises: a first clamp spaced apart from a second clamp and collectively arranged to clamp a length of fiber extending in an axial direction; a tensioner configured to translate at least one of the first and second clamp away from the other clamp to tension the length of the fiber; and a blade configured to score the tensioned length of fiber between the first and second clamps to generate a substantially perpendicular cleave in the fiber. The first clamp is configured to clamp an intermediate section of the fiber. The second clamp is an adhesive clamp that includes a substrate having an application area configured to receive a portion of fiber and an adhesive applied to the application area of the substrate in a liquid state, wherein the adhesive takes a solid state when cured to form a substantially torsion-free clamp of the portion of the fiber to the substrate.

In some embodiments, the first clamp is a mechanical clamp.

In some embodiments, the first clamp includes a substrate having an application area configured to receive a portion of at least one fiber and an adhesive applied to the application area of the substrate in a liquid state, wherein the adhesive takes a solid state when cured to form a substantially torsion-free clamp of the portion of the at least one fiber to the substrate.

In some embodiments, the substrate includes at least one adhesion enhancer.

In some embodiments, the at least one adhesion enhancer takes the form or a pattern or texture formed in the application area.

In some embodiments, the substrate includes a groove formed in the application area to receive the portion of the fiber.

In some embodiments, the groove has a V-shaped cross section.

In some embodiments, the groove has a U-shaped cross section.

In some embodiments, the application area is a substantially flat surface.

In some embodiments, the substrate is a bowl.

In some embodiments, the bowl includes an opening sized for passage of the fiber.

In some embodiments, the adhesive is an epoxy adhesive.

In some embodiments, the epoxy is an ultraviolet-cured epoxy.

In some embodiments, the cured adhesive exhibits a relatively high pull strength to peel strength ratio.

In some embodiments, the substrate comprises and/or is made of glass.

In some embodiments, the substrate comprises and/or is made of stainless steel.

In some embodiments, the substrate comprises and/or is made of plastic.

In some embodiments, the application area is configured to receive an end or endface of the at least one fiber.

In some embodiments, the application area is configured to receive an intermediate portion of the at least one fiber.

In some embodiments, the adhesive clamp is a torsion-free, substantially uniform force clamp.

In according with another aspect of the inventive concept, provided is a method of cleaving a fiber, comprising: clamping an intermediate portion of the fiber with a first clamp; clamping a second portion of the fiber with a second clamp that is linearly spaced apart from the first clamp so that a length of the fiber between the first and second clamps extends in an axial direction; translating at least one of the first and second clamps away from the other of the first and second clamps to tension the fiber; and scoring a surface of the fiber between the first and second clamps to generate a substantially perpendicular cleave in the fiber. Clamping with the second clamp includes: positioning the second portion of the fiber on an application area of a substrate of the second clamp; applying an adhesive to the second portion of the fiber and the application area of the substrate; and transitioning the adhesive to a solid state, thereby clamping the fiber to the substrate with a substantially torsion free clamp.

In some embodiments, the adhesive is an epoxy.

In some embodiments, transitioning of the adhesive to a solid state includes curing the epoxy.

In some embodiments, transitioning of the adhesive to a solid state includes ultraviolet curing of the epoxy.

In some embodiments, the transitioning of the adhesive to a solid state includes adding a curing agent to the epoxy.

In some embodiments, the cured adhesive exhibits a relatively high pull strength to peel strength ratio.

In some embodiments, the transitioning of the adhesive to a solid state includes air hardening of the adhesive.

In some embodiments, the substrate includes at least one adhesion enhancer.

In some embodiments, the at least one adhesion enhancer takes the form or a pattern or texture formed in the application area.

In some embodiments, the substrate includes a groove formed in the application area to receive the portion of the at least one fiber.

In some embodiments, the groove has a V-shaped cross section.

In some embodiments, the groove has a U-shaped cross section.

In some embodiments, the application area is a substantially flat surface.

In some embodiments, the substrate is a bowl.

In some embodiments, the bowl includes an opening sized for passage of the at least one fiber.

In some embodiments, the substrate comprises and/or is made of glass.

In some embodiments, the substrate comprises and/or is made of stainless steel.

In some embodiments, the substrate comprises and/or is made of plastic.

In some embodiments, the application area is configured to receive an end or endface of the at least one fiber.

In some embodiments, the application area is configured to receive an intermediate portion of the at least one fiber.

In some embodiments, the substantially torsion-free clamp is a substantially uniform force clamp.

In accordance with another aspect of the inventive concept, provided is an adhesive clamp as shown and described.

In accordance with another aspect of the inventive concept, provided is an epoxy clamp as shown and described.

In accordance with another aspect of the inventive concept, provided is a fiber cleaver having an epoxy clamp as shown and described.

In accordance with another aspect of the inventive concept, provided is a method of clamping a portion of an optical fiber as shown and described.

In accordance with another aspect of the inventive concept, provided is a method of cleaving a fiber using at least one epoxy clamp as shown and described.

### BRIEF DESCRIPTION OF THE DRAWINGS

Inventive concepts will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating principles of inventive concepts. In the drawings:

FIG. 1 is a high-level view of a conventional fiber cleaver having two mechanical clamps;

FIGS. 2A and 2B are perspective views of exemplary embodiments of adhesive clamps, in accordance with principles of inventive concept;

FIGS. 2C through 2E are front views of exemplary embodiments of adhesive clamps, in accordance with principles of inventive concept;

FIG. 2F is a perspective view of another exemplary embodiment of an adhesive clamp, in accordance with principles of inventive concept;

FIGS. 2G through 2J are front views of other exemplary embodiments of an adhesive clamp, in accordance with principles of inventive concept;

FIGS. 3A through 3F show views of various embodiments a fiber cleaver employing primary and secondary clamps, including at least one adhesive (or epoxy) clamp, in accordance with principles of inventive concept;

FIG. 3G is a side view of embodiment of a vertically oriented fiber cleaver employing at least one adhesive (or epoxy) clamp, in accordance with principles of the inventive concept;

FIG. 3H is a top view of the adhesive (epoxy) container of FIG. 3G, in accordance with aspects of the inventive concept;

FIG. 3I is a top view of the adhesive (epoxy) container of FIG. 3G with an adhesive enhancer, in accordance with aspects of the inventive concept;

FIG. 3J is a side view of embodiment of a vertically oriented fiber cleaver employing at least one adhesive (or epoxy) clamp that allows a fiber to pass through, in accordance with principles of the inventive concept;

FIG. 3K is a top view of the adhesive (epoxy) container of FIG. 3J, in accordance with aspects of the inventive concept;

FIG. 3L is a top view of the adhesive (epoxy) container of FIG. 3J with an adhesive enhancer, in accordance with aspects of the inventive concept;

FIG. 4 is a is a high-level view of an embodiment of a fiber cleaver having a grooved adhesive clamp, in accordance with principles of inventive concept;

FIG. 5 is a flowchart of an exemplary embodiment of a method of clamping a fiber using at least one adhesive clamp, in accordance with principles of inventive concept; and

FIG. 6 is a flowchart of an embodiment of a method of cleaving a fiber using at least one adhesive clamp, in accordance with principles of inventive concept.

### DETAILED DESCRIPTION OF PREFERRED EMBODIMENTS

Hereinafter, aspects of inventive concepts will be described by explaining illustrative embodiments in accordance therewith, with reference to the attached drawings. While describing these embodiments, detailed descriptions of well-known items, functions, or configurations are typically omitted for conciseness.

It will be understood that, although the terms first, second, etc. are be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of inventive concepts. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of inventive concepts. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

Spatially relative terms, such as “beneath,” “below,” “lower,” “above,” “upper” and the like may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements or features would then be oriented “above” the other elements or features. The device may be otherwise oriented (e.g., rotated 90 degrees or at other orientations) and the spatially relative descriptors used herein interpreted accordingly.

In accordance with the present inventive concepts, provided is a fiber processing apparatus that includes at least one torsion-free adhesive clamp configured to secure an end, endface, or intermediate portion of one or more optical fibers. As used herein, a “torsion-free clamp” is a clamp that does not inherently torque optical fiber(s) secured therein. In the preferred form, the torsion-free clamp uses an epoxy that transitions from a liquid state to a solid state as the fiber-securing element, which can be referred to as an “epoxy clamp.” The epoxy can be an adhesive, such as glue, or other material made from a class of synthetic thermosetting polymers containing epoxide groups that transitions from a liquid state to a solid state when exposed air or similar environment and/or ultraviolet (UV) light. As used herein, the term “epoxy” could also include other polymer glues, bonding agent, and/or plastic resin that transitions from a liquid state to a solid state when exposed to air or similar environment and/or ultraviolet (UV) light. The adhesive clamp preferably does not require heating or cooling to transition from a liquid state to a solid state or from a solid state to a liquid state.

An example of such an epoxy is NBA Blocking Adhesive 107 by Norland Products, Inc., which cures by exposure to UV light in the range of 350 to 380 nanometers; this is just one possible example. Another example is an adhesive, such as Loctite 366, that is capable of holding 4-5 kilos of tension (sufficient for cleaving 1.0 to 1.2 mm), but is not easily removable. In various embodiments, the epoxy can be applied to the substrate to have a gluing length of up to 100 mm.

Using epoxy for clamping, the cycle time is preferably not more than about 30 seconds (±10 seconds), which is several times faster than liquid metal clamps discussed in U.S. Pat. No. 8,977,098. The inventive concept is not limited to such time constraints, however. The result is much greater efficiency, particularly when volumes of clamping (and cleaving) operations are performed. In accordance with aspects of the inventive concept, less maintenance is required, since there is no need to provide and replace liquid metal or components associated with heating/cooling. From a utility perspective, unlike the liquid metal clamp, a significant benefit of the epoxy clamp is that it can be used in a horizontal orientation. The horizontal orientation is far more desirable, since cleavers are typically oriented horizontally.

In exemplary embodiments in accordance with principles of inventive concept, the adhesive clamp can employ a substrate in combination with an epoxy to clamp at least one fiber, e.g., a single fiber or multi-strand fiber. The substrate provides a surface to support the optical fiber(s) and receive the adhesive/epoxy in a liquid state. Once the adhesive transitions to a solid state, e.g., by drying or curing, a torsion-free clamp of the fiber is achieved by the adhesive clamp.

In a cleaving operation, for example, another portion of the fiber can clamped—preferably before clamping with the adhesive clamp. The first clamp could be a mechanical clamp, an adhesive clamp or a liquid metal clamp. If a mechanical clamp is used, it is particularly important to clamp first with the mechanical clamp and then with the adhesive clamp. After both portions of the fiber are clamped, the fiber is tensioned and then cleaved by scoring a surface of the fiber with a blade. Tensioning causes the score to form a crack that propagate orthogonally across the fiber. The blade is preferably oriented perpendicular to the surface of the fiber, or a central axis of the fiber. The adhesive clamp preferably produces cleave angles 0.25 degrees or less.

The substrate may be relatively flat or it may include a groove into which the fiber is placed. The adhesive may be a relatively fast-acting adhesive or epoxy and, in exemplary embodiments, may exhibit a relatively high pull-strength to peel-strength ratio. The substrate may be made of stainless steel (for example, 410 stainless), plastic, glass, or other material to which the adhesive and/or epoxy bonds without deterioration.

In exemplary embodiments, the substrate may be a single-use or a multi-use substrate. That is, in single-use embodiments, an adhesive clamp may be employed for a single operation (for example, cleaving), then discarded. In other exemplary embodiments, the adhesive clamp may be used for a plurality of operations, or cycles.

A single-use adhesive clamp may employ a relatively inexpensive substrate, such as a plastic or glass substrate and, in operation, an end (or “endface”) or intermediate portion of a fiber may be adhered to the substrate. After use, such as cleaving, the substrate and fiber-end left adhering to it may be discarded. One example of such a substrate is microscope slides, which are relatively inexpensive. Such slides can be a flat, thin piece of glass having a rectangular shape of about 3 inches×1 inch. Other known types of microscope slides could optionally be used in various embodiments.

In multi-use embodiments, a more substantial substrate, such as a metal (e.g., stainless steel) or thicker glass, plastic or resin substrate can be used. As discussed above, a fiber end or intermediate portion is adhered to the substrate with an adhesive, e.g., an epoxy. After an operation, such as cleaving, the fiber can be removed from the substrate in order to reuse the substrate for a subsequent operations.

In various embodiments, the adhesive can be removed from the substrate in various ways, such as by thermal breakdown, peeling, chemical or solvent. That is, in some embodiments, the adhesive can be mechanically removed from the substrate. For example, in some embodiments, the adhesive can be peeled away from the substrate and/or fiber. In other embodiments, the adhesive and/or fiber can be chemically removed from the substrate. In other embodiments, the fiber could be de-bonded from the substrate using a solvent, such as acetone, for example.

In embodiments in which the substrate is re-used and the fiber end, or remainder, is peeled off the substrate, the pull-strength to peel-strength ratio of the adhesive may be of greater significance, because although it is important for the fiber to remain affixed to the substrate as tension is applied to the fiber during a cleaving operation, it is also important that the fiber be readily removable from the substrate, by peeling, after the cleaving operation is performed. Pull strength may be enhanced by forming adhesion enhancers on the substrate, either on top of the substrate in a surface-mounted implementation or within a groove in a groove-mounted implementation. Such adhesion-enhancement may take the form of cross-grooves or knurling, as examples.

Employing a clamp adhesive in accordance with principles of inventive concept provides sufficient gripping force to apply tension to a fiber during a cleaving process while reducing torsional load that may be imparted using conventional clamps.

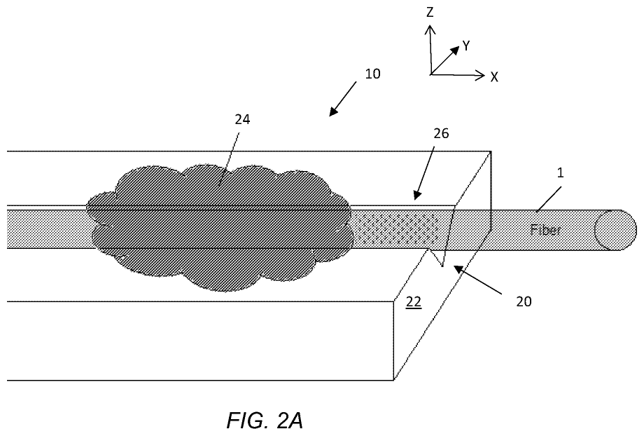

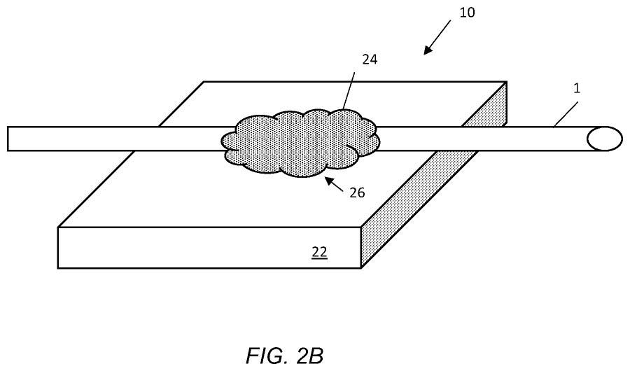

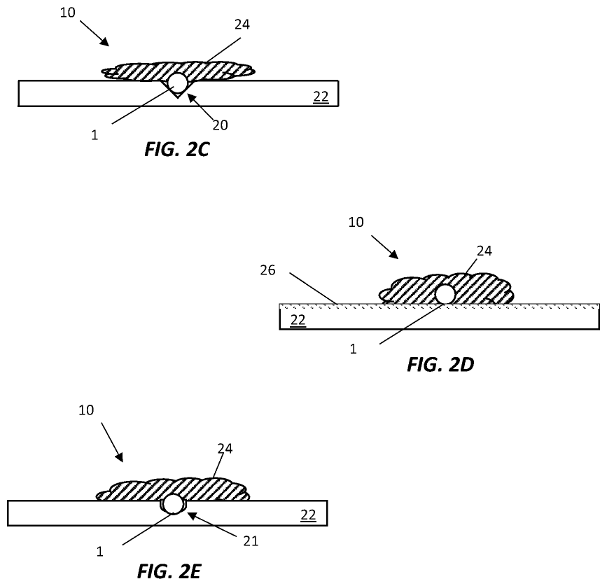

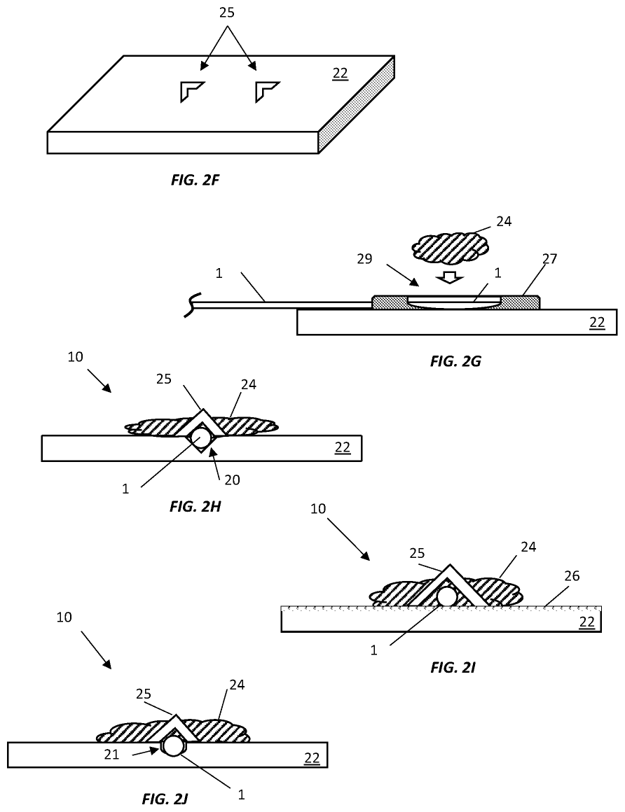

FIGS. 2A and 2B are perspective views of exemplary embodiments of adhesive (epoxy) clamps in accordance with principles of inventive concepts. FIGS. 2C through 2E provide front views of other exemplary embodiments of adhesive clamps in accordance with principles of inventive concepts. FIG. 2F is a perspective view of another exemplary embodiment of an adhesive clamp, in accordance with principles of inventive concepts. And FIGS. 2G through 2J are front views of still other exemplary embodiments of an adhesive clamp, in accordance with principles of inventive concepts.

FIGS. 2A and 2B provide exemplary embodiments of a torsion-free clamp 10, in the forms of a V-groove clamp and a surface-mount clamp, respectively, in accordance with principles of inventive concepts. In the V-groove clamp embodiment of FIG. 2A, a fiber 1 is situated or disposed in a groove 20 formed within a substrate 22. In various embodiments, groove 20 may exhibit any of a variety of cross-sectional shapes, in this case it is a “V” shaped groove 20, but in other embodiments it could be, for example, a “U” shaped groove, or an open rectangular channel, as another example.

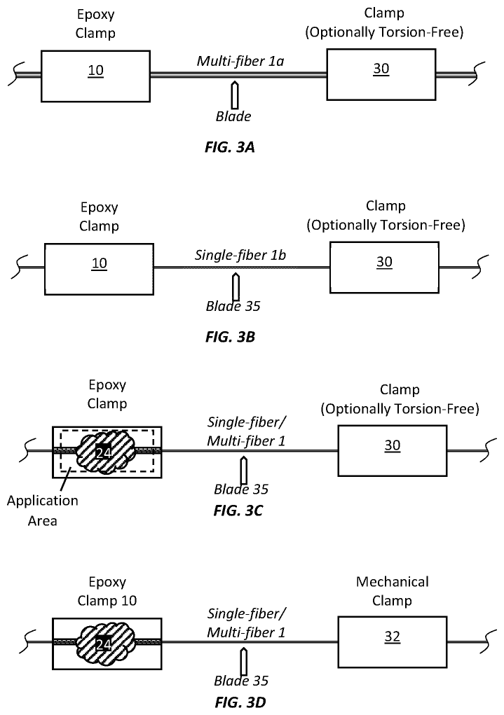

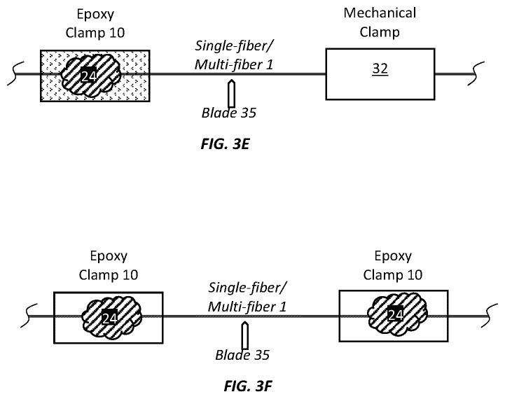

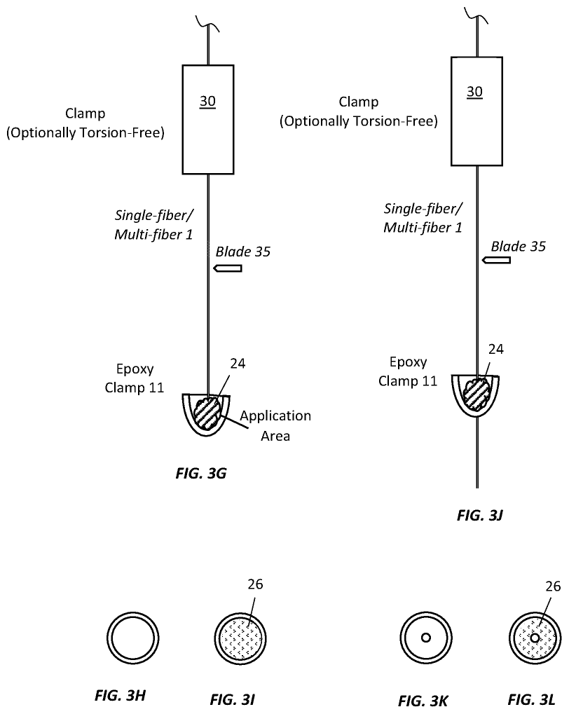

Substrate 22 may be formed of any of a variety of materials, as discussed above. These materials include, but are not limited to, stainless steel, glass, or any of a variety of plastic materials, for example. In single-use embodiments, substrate 22 may employ a relatively inexpensive material, such as a paper substrate, a thin-plastic substrate, or a microscope slide, and in multi-use embodiments substrate 22 may be formed of a more durable, but more expensive, material, such as 410 stainless steel or durable, e.g., thick, plastic or glass. An epoxy 24 is applied in a fluid (or liquid) state to both the fiber 1 and the substrate 22 on which it is disposed. The area of the slide configured to receive the portion of the fiber 1 and the epoxy 24 may be referred to as an “application area” of the substrate (e.g., See FIGS. 3C and 3G), which can accommodate a gluing length of up to 100 mm.

The epoxy is applied so that it covers a portion of the fiber 1 and surrounding portions of the substrate 22. Once the epoxy 24 transitions to a solid state, e.g., by curing or drying, a torsion-free clamp 10 of the fiber 1 to the substrate 22 is achieved. In the liquid (or fluid) state, the epoxy does not apply any torque to the fiber 1, e.g., it is torsion-free. Similarly, the process of transitioning to the solid state does not add any torque to the fiber 1, as the epoxy cures or dries in place. Accordingly, a torsion-free clamp 10 is achieved. In various exemplary embodiments, the torsion-free clamp 10 does not require heating or cooling to achieve either the liquid or solid states. Although, in some embodiments, UV light can be used to accelerate curing.

In exemplary embodiments, epoxy 24 is relatively fast-acting. Preferably, epoxies that cure within 2 minutes or less may be used and, more preferably, epoxies that cure within 1 minute or less, may be used, and, even more preferably, epoxies that cure within 30 seconds, or less may be used. Such epoxies may be ultraviolet-cured, heat-cured, or compound epoxies that employ a curing-agent, for example. Sufficient curing agent, whether it be ultraviolet light, heat, or a curing compound (in a two-part epoxy, for example), can be applied according to manufacturers' directions to cure the adhesive within a desired time frame. Additionally, the curing agent can be applied in a manner that yields uniform spatial curing so that, for example, adhesive on one side of the fiber does not cure more rapidly than the other and thereby, potentially, impart a torque to the fiber. Despite approaches to accelerating curing, the adhesive or epoxy begins in a liquid or fluid state without heating; it is a liquid at ambient and/or room temperature.

Groove 20 may be sized and shaped so that epoxy 24 is distributed around the fiber substantially uniformly and contracts around the fiber substantially equally during the curing process. In exemplary embodiments, the epoxy may extend from ten millimeters to ten centimeters in a first direction X and from one millimeter to one centimeters in a second direction Y and may provide sufficient grip to withstand a pulling force of from ten to one hundred Newtons and, more particularly, from fifty to sixty Newtons, which may be applied to the fiber 1 during a cleaving process, for example.

The epoxy 24 may be applied to the substrate 22 before and/or after placement of the fiber 1, in some embodiments producing a relatively evenly-coated fiber. Because epoxies exhibit a relatively high sheer strength and low peel strength, they may be used to particular advantage in a re-usable adhesive clamp, in accordance with principles of inventive concept. As will be described in greater detail below, an epoxy clamp in accordance with principles of inventive concept may be employed as a primary or secondary clamp, or in both capacities, in a cleaving system and method in accordance with principles of inventive concepts.

An epoxy clamp in accordance with principles of inventive concepts yields low cleavage angles on fiber bundles, tapered assemblies, and shaped and round fibers. In addition to producing low cleavage angles, an epoxy clamp in accordance with principles of inventive concept avoids damage to fibers that may otherwise occur with a mechanical clamp. That is, conventional mechanical clamps require the application of a downward force to grip the fiber (which maybe a single fiber, a fiber bundle, or capillary) and such force may damage or break the fiber. Additionally, because the adhesive may cure relatively quickly, a process employing an adhesive (epoxy) clamp in accordance with principles of inventive concepts may be cycled relatively rapidly.

Adhesion enhancers 26 (see also FIG. 3D) may be formed within groove 20 to strengthen the bond between fiber 1 and substrate 22 in a first direction X in line with the axis of fiber 1, to thereby ensure that the bond will hold as tension is applied to fiber 1, during a cleaving operation, for example. Adhesion enhancers 26 may include knurling, cross-channeling, or other features that provide better adhesion in first direction X between substrate 22 and fiber 1, while having a lesser impact on adhesion in second Y and third Z directions. Such adhesion enhancers, therefore, my take the form of a rough, textured, or patterned top surface of substrate 20, to which the epoxy 24 is applied. By enhancing the bond strength in the first X direction (in line with tension applied to fiber 1) to a greater extent than in the second Y and third Z directions, the ratio of pull-strength to peel-strength may be increased. This may be particularly advantageous in embodiments in which a substrate is re-used, allowing for relatively easy removal of fiber 1 from substrate 22 after completion of, for example, a cleaving process.

In the exemplary embodiment of FIG. 2B, fiber 1 is mounted on the top surface of substrate 22 and an epoxy is applied thereto. In this embodiment, the top surface does not have a groove formed therein. Therefore, the top surface may be considered a continuous surface, which is generally planar in this example. A generally planar surface need not be perfectly smooth, and may have adhesion enhancers, such as text, patterns, or roughness. Thus, as with the groove-mounted exemplary embodiment of FIG. 2A, an adhesion enhancer 26 may be formed on substrate 22 to strengthen the bond between the epoxy 24, fiber 1 and substrate 22.

FIG. 2C shows a front end view an embodiment of a clamp 10 having a V-groove, as in FIG. 2A. As shown, fiber 1 resides, at least partially, in the V-groove 20 formed in the substrate 22. Epoxy 24 is applied on top of fiber 1 and substrate 22. Once the epoxy 24 is cured, the clamp 10 is formed. The top surface and/or the V-groove could optionally include an adhesion enhancer, in various embodiments.

FIG. 2D shows a front end view an embodiment of a clamp 10 having no groove, as in FIG. 2B. As shown, fiber 1 resides on a top surface of the substrate 22. Epoxy 24 is applied on top of fiber 1 and substrate 22. In this embodiment, the top surface includes as an adhesion enhancer 26. Once the epoxy 24 is cured, the clamp 10 is formed.

FIG. 2E shows a front end view an embodiment of a clamp 10 having a U-shaped groove (or “U-groove”) 21. As shown, fiber 1 resides, at least partially, in the U-groove 21 formed in the substrate 22. Epoxy 24 is applied on top of fiber 1 and substrate 22. Once the epoxy 24 is cured, the clamp 10 is formed. The top surface and/or the U-groove could optionally include an adhesion enhancer, in various embodiments.

FIG. 2F shows an embodiment of a substrate with built-in guide, formed on the top surface of the substrate 22. The built-in guides can help position and maintain the fiber on the slide for application of the epoxy. Two guides 25 are shown in this embodiment, but the present inventive concept is not so limited. In other embodiments, a single guide or more than two guides could be used. In this embodiment, the guides 25 take the form of a structural element that forms an opening with the substrate, which can be referred to as a fiber guide opening. In various embodiments, the epoxy 24 can be applied between the guides when a fiber (not shown) passes through the guides 25.

FIG. 2G is another embodiment of a substrate with a guide. Here, guide 27 is formed on or coupled to a top surface of substrate 22. A fiber 1 is passed into guide 27. Guide 27 could have an open end that receives the fiber 1 and an opposite closed end as a terminus of an end or endface of the received fiber 1 (which can be a multi-strand fiber). In other embodiments, guide 27 can have two open ends. Guide 27 can also include at least one opening or window 29 formed therein. The window 29 can be sized and arranged to receive application of an epoxy 24 used to secure the fiber 1 to the substrate.

FIG. 2H shows a front end view an embodiment of a clamp 10 having a V-groove, as in FIG. 2A. As shown, fiber 1 resides, at least partially, in the V-groove 20 formed in the substrate 22. The fiber 1 is maintained by one or more guides 25, as in FIG. 2F. The guides 25 and V-groove 20 form a bounded channel with open ends that generally maintain the fiber 1 on the substrate 22 for application of the epoxy 24. Epoxy 24 is applied on top of fiber 1 and substrate 22, e.g., between at least two guides 25. Once the epoxy 24 is cured, the clamp 10 is formed. The top surface and/or the V-groove could optionally include an adhesion enhancer, in various embodiments.

FIG. 2I shows a front end view an embodiment of a clamp 10 having a V-groove, as in FIG. 2F. As shown, fiber 1 resides, at least partially, in the V-groove 20 formed in the substrate 22. As shown, fiber 1 resides on a top surface of the substrate 22. In this embodiment, the top surface includes as an adhesion enhancer 26. The guides 25 form a bounded channel with open ends that generally maintain the fiber 1 on the substrate 22 for application of the epoxy 24. Epoxy 24 is applied on top of fiber 1 and substrate 22, e.g., between at least two guides 25. Once the epoxy 24 is cured, the clamp 10 is formed.

FIG. 2J shows a front end view an embodiment of a clamp 10 having a U-groove, as in FIG. 2E. As shown, fiber 1 resides, at least partially, in the U-groove 21 formed in the substrate 22. The fiber 1 is maintained by one or more guides 25, as in FIG. 2F. The guides 25 and U-groove 21 form a bounded channel with open ends that generally maintain the fiber 1 on the substrate 22 for application of the epoxy 24. Epoxy 24 is applied on top of fiber 1 and substrate 22, e.g., between at least two guides 25. Once the epoxy 24 is cured, the clamp 10 is formed. The top surface and/or the U-groove could optionally include an adhesion enhancer, in various embodiments.

FIGS. 3A through 3F show top views of various embodiments a fiber cleaver employing primary and secondary clamps, including at least one adhesive (or epoxy) clamp, in accordance with principles of inventive concepts.

FIG. 3A shows a cleaver embodiment having a first clamp 30 being optionally a torsion-free clamp, i.e., an epoxy clamp. Clamp 30 can be either a mechanical clamp or a torsion-free clamp, e.g., epoxy clamp 10 discussed above. The second clamp is an epoxy clamp 10, such as those described above. For purposes of illustration, a multi-fiber (or multi-strand fiber) 1a is shown secured by the clamps 10, 30. Once secured by both clamps 10, 30, or both of clamps 10 and 30 can be translated away from the other to apply tension to the portion of the fiber 1a between the clamps 10, 30. Once under tension, a blade 35 is arranged to score the fiber 1a. The tensioning causes the scratch resulting from the score to propagate through the fiber 1a to achieve a cleave, preferably having a cleave angle of 0.25 degrees or less.

FIG. 3B is similar to the cleaver embodiment of FIG. 3A, except a single-fiber (or single strand fiber) 1a is shown instead of a multi-fiber 1b. The clamping, tensioning, then cleaving process is the same as with FIG. 3A.

FIG. 3C shows a cleaver embodiment that is similar to that of FIG. 3B. In this embodiment, the epoxy clamp 10 includes a groove or channel, e.g., V-groove 20 or U-groove 21 discussed above.

FIG. 3D shows a cleaver embodiment similar to that of FIG. 3C, including an epoxy clamp 10 and a mechanical clamp 32. To achieve a torsion-free clamp, the mechanical clamp 32 is clamped before the epoxy clamp 10, since any torque applied to the fiber 1 from the mechanical clamp will be relieved by use of the epoxy clamp 10. In this embodiment, the epoxy clamp 10 includes a groove or channel, e.g., V-groove 20 or U-groove 21 discussed above.

FIG. 3E is similar to the cleaver embodiment of FIG. 3C, where the first clamp 30 is a mechanical clamp that the second clamp is an epoxy clamp 10. Additionally, the substrate 22 of the epoxy clamp is shown with an adhesion enhancer 26. Any of the epoxy clamps in FIGS. 2A trough 2J and/or FIG. 3A though 3I can include an adhesion enhancer 26.

FIG. 3F is a cleaver embodiment including a plurality of epoxy clamps 10, here a first epoxy clamp 10 and a second epoxy clamp 10. Otherwise, the embodiment of FIG. 3F is similar to the embodiments of FIGS. 3A through 3E.

FIG. 3G is a side view of an embodiment of a vertically oriented fiber cleaver employing at least one adhesive (or epoxy) clamp, in accordance with principles of the inventive concept. FIG. 3G shows a first clamp 30 that is optionally a torsion-free clamp. That is, clamp 30 could be an epoxy clamp 10 or 11 or a mechanical clamp 32. One or more fibers 1 is/are clamped by the first clamp 30 and then by the second clamp, i.e., the epoxy clamp 11.

Epoxy clamp 11 differs from epoxy clamp 10 in that epoxy clamp 11 includes a substrate in the form of a bowl 28. FIG. 3G shows the bowl in cross-section. In this embodiment, an end or endface of fiber 1 terminated in the bowl 28, which is shaped to hold epoxy 24. Again, after the fiber 1 is secured by the first clamp 30 and then the epoxy clamp 11, one or both of the clamps can be translate away from the other to tension the fiber 1. Once under tension, blade 35 is used to score a surface of the fiber 1, and due to the tension the score in the surface becomes a crack that propagate through the fiber 1 to generate the cleave, and a cleaved fiber. In accordance with aspects of the inventive concept, a cleave having a cleave angle of 0.25 degrees or less is preferably achieved.

FIG. 3H is a top view of an embodiment of a bowl 28 of clamp 11 without an adhesive enhancer and FIG. 3I is a top view of an embodiment of a bowl 28 of clamp 11 with an adhesive enhancer 26.

FIG. 3J is a side view of another embodiment of a vertically oriented fiber cleaver employing at least one adhesive (or epoxy) clamp, in accordance with principles of the inventive concept. The cleaver of FIG. 3J is different from the cleaver of FIG. 3G in that the bowl 28 includes an opening 29 in its bottom to allow the fiber to pass through.

FIG. 3K is a top view of an embodiment of a bowl 28 of clamp 11 without an adhesive enhancer and FIG. 3L is a top view of an embodiment of a bowl 28 of clamp 11 with an adhesive enhancer 26.

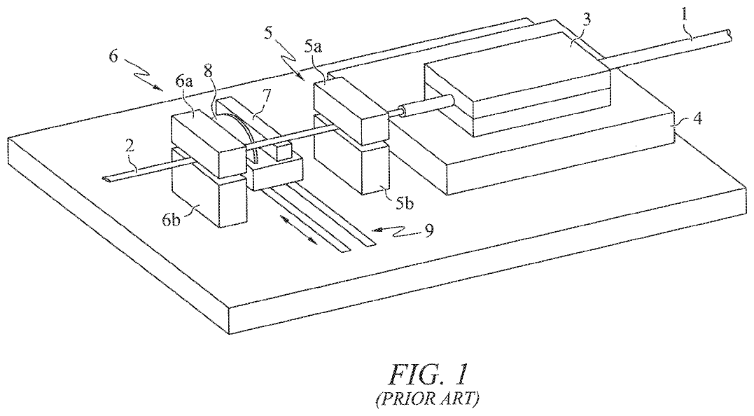

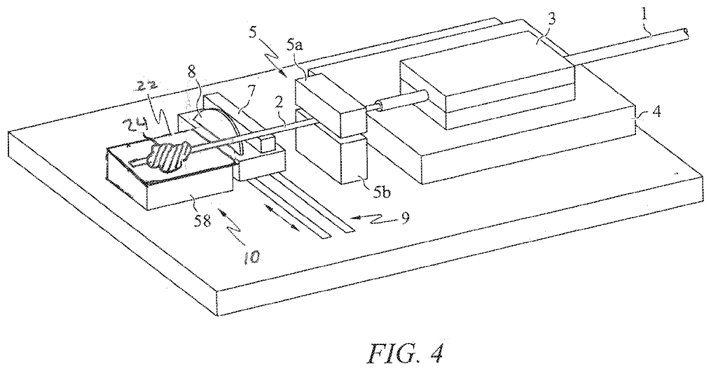

FIG. 4 shows an exemplary embodiment of a fiber cleaver system having a mechanical clamp (first clamp) and an epoxy clamp (second clamp) employing a substrate, in accordance with principles of inventive concept. In the embodiment of FIG. 4, a clamping system uses first clamp 5 described with respect to FIG. 1, along with fiber hold down member 3, resting table 4, slider 7 and blade 8. Repeated description of these elements common to FIG. 1 is omitted here, for the sake of clarity and brevity.

Fiber 1, 2 (or set of fibers) and holding and cleaving elements are horizontally oriented so that a second portion of the fiber 2, which is preferably stripped of any coatings, can be positioned and secured in the epoxy clamp 10 of this embodiment. As discussed above, the fiber is secured in the epoxy clamp 10 after being secured by mechanical clamp 5, so that any torque applied by the mechanical clamp 5 is relieved before use of the epoxy clamp. Since the epoxy clamp 10 is a torsion-free clamp that does not introduced torque on fiber 1, the portion of fiber 1 clamped between the mechanical clamp 5 and the epoxy clamp 24 is substantially or completely torque- or torsion-free.

Epoxy clamp 10 includes a substrate 22 arranged in an optional platform 13 that supports the substrate 22. Once the fiber 1, 2 is disposed on the substrate 22, epoxy 24 is applied in a liquid form on the fiber portion 2 and substrate 22. The fiber is maintained by epoxy 24 on the substrate 22 once the epoxy transitions to a solid state. That is, epoxy 24 preferably takes a liquid form until cured. The curing can be accelerated by, as examples, application of ultraviolet light or the addition of a curing agent.

In the various embodiments, the fiber 1 can be a single fiber of small or large diameter, e.g., diameters above 40 μm. The fiber 1 can have a circular cross section or a non-circular cross section (e.g., oval). The fiber 1 can be a plurality of fibers, e.g., a ribbon or bundle of fibers. The plurality of fibers can, for example, include a center fiber and a plurality of fibers distributed about the center fiber (in parallel). The fiber or plurality of fibers can be collectively referred to as a “set of fibers.” The set of fibers can include any known fiber or plurality of fibers, and those developed hereafter.

For small diameter fibers (e.g. less than 40 μm in diameter), a cleave that is two degrees or less off perpendicular is desirable. For large diameter fibers (e.g. equal to or greater than 40 μm in diameter), a cleave that is half a degree or less off perpendicular is desirable. The clamp achieved by the epoxy 24 achieving the solid state, which provides a fiber-conforming, substantially uniform force clamp—that is substantially torsion free. As a result, a cleave of a fiber clamped in this way will tend to have a negligible angle relative to a line that is perpendicular to a central axis (or outer surface) of the fiber, e.g., an angle less than about 0.5° and in exemplary embodiments less than about 0.2°. These results can be achieved regardless of the outer shape of the fiber, fiber strip, or fiber bundle, as the case may be.

In this exemplary embodiment of a clamp and cleaver, after cleaving, the epoxy can be removed using a solvent, such as acetone, for example, the fiber removed from the substrate, and the substrate could optionally be used for another clamping and/or cleaving operation. Alternatively, with an appropriate pull strength to peel strength ratio, the cleaved off fiber end and epoxy can be peeled away, and the substrate re-used for another clamping and/or cleaving operation. In single-use embodiments, those that employ a disposable substrate 22, the fiber end may be left adhered to the substrate and the fiber end and substrate discarded and replaced with a new substrate.

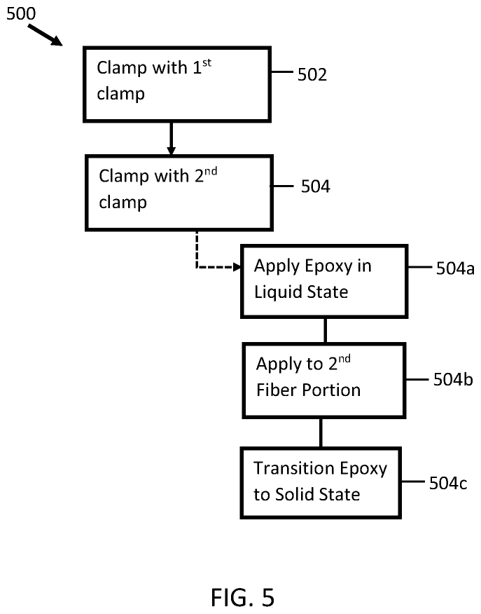

FIG. 5 is a flowchart of an exemplary embodiment of a method of clamping a fiber in accordance with principles of inventive concepts. The method 500 includes clamping a first portion of a fiber (or set of fibers) with a first clamp in step 502, e.g., a mechanical clamp. The method includes, after step 502, clamping a second portion of the fiber with a second clamp that is an epoxy clamp in accordance with principles of inventive concepts, in step 504. The second portion may be an end, end face, or intermediate portion of the fiber. Step 504 includes providing an epoxy in a liquid form in step 504a; positioning a second portion of the set of fibers in the adhesive in the liquid form, in step 504b; and drying or curing the epoxy (e.g., via UV irradiation, for example) so that the epoxy takes a solid form, thereby securing the second portion of the set of fibers to the substrate, in step 504c.

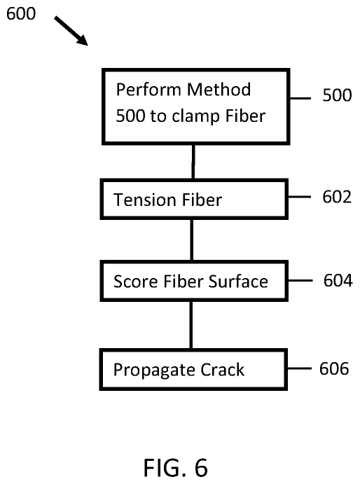

FIG. 6 is a flowchart of an embodiment of a method of cleaving a fiber using an epoxy clamp, in accordance with principles of inventive concepts. Method 600 includes performing the method 500 of FIG. 5, wherein additional steps are added thereafter. In step 602, a portion of the fiber between the clamps is tensioned by translating at least one (or both) of the first and second clamps. The translation is preferably in the direction of the axis of the fiber between the clamps. A surface of the set of fibers is scored in step 604, causing propagation of a crack through the set of fibers to create a cleave, in step 606.

In some cases, multiple epoxy clamps could be used. For example, in the above embodiments the first clamp could also be an epoxy clamp.

Those skilled in the art will appreciate that the epoxy clamp disclosed herein can have utility beyond that disclosed for fiber cleavers, e.g., for stripping and/or splicing. Depending on the use, the epoxy clamp could be the only clamp, where a first, or primary, clamp is not needed.

While the foregoing has described what are considered to be the best mode and/or other preferred embodiments, it is understood that various modifications can be made therein and that inventive concepts may be implemented in various forms and embodiments, and that they may be applied in numerous applications, only some of which have been described herein. It is intended by the following claims to claim that which is literally described and all equivalents thereto, including all modifications and variations that fall within the scope of each claim.

1. A fiber clamp, comprising:
a substrate having an application area configured to receive a portion of at least one fiber; and
an adhesive applied to the application area of the substrate in a liquid state, wherein the adhesive takes a solid state when cured to form a substantially torsion-free clamp of the portion of the at least one fiber to the substrate.

2. The fiber clamp of claim 1, wherein the substrate includes at least one adhesion enhancer.

3. The fiber clamp of claim 2, where the at least one adhesion enhancer takes the form or a pattern or texture formed in the application area.

4. The fiber clamp of claim 1, wherein the substrate includes a groove formed in the application area to receive the portion of the at least one fiber.

5. The fiber clamp of claim 4, wherein the groove has a V-shaped cross section.

6. The fiber clamp of claim 4, wherein the groove has a U-shaped cross section.

7. The fiber clamp of claim 1, wherein the application area is a substantially flat surface.

8. The fiber clamp of claim 1, wherein the substrate is a bowl.

9. The fiber clamp of claim 8, wherein the bowl includes an opening sized for passage of the at least one fiber.

10. The fiber clamp of claim 1, wherein the adhesive is an epoxy adhesive.

11. The fiber clamp of claim 10, wherein the epoxy is an ultraviolet-cured epoxy.

12. (canceled)

13. The fiber clamp of claim 1, wherein the substrate comprises and/or is made of glass, stainless steel, and/or plastic.

14.-15. (canceled)

16. The fiber clamp of claim 1, wherein the application area is configured to receive an end or endface of the at least one fiber.

17. The fiber clamp of claim 1, wherein the application area is configured to receive an intermediate portion of the at least one fiber.

18. The fiber clamp of claim 1, wherein the substantially torsion-free clamp is a substantially uniform force clamp.

19. A fiber cleaver system with an adhesive clamp, comprising:
a first clamp spaced apart from a second clamp and collectively arranged to clamp a length of fiber extending in an axial direction;
a tensioner configured to translate at least one of the first and second clamp away from the other clamp to tension the length of the fiber; and
a blade configured to score the tensioned length of fiber between the first and second clamps to generate a substantially perpendicular cleave in the fiber, wherein:
the first clamp is configured to clamp an intermediate section of the fiber; and
the second clamp includes:
a substrate having an application area configured to receive a portion of fiber; and
an adhesive applied to the application area of the substrate in a liquid state, wherein the adhesive takes a solid state when cured to form a substantially torsion-free clamp of the portion of the fiber to the substrate.

20. (canceled)

21. The system of claim 19, wherein the first clamp includes:
a substrate having an application area configured to receive a portion of at least one fiber; and
an adhesive applied to the application area of the substrate in a liquid state, wherein the adhesive takes a solid state when cured to form a substantially torsion-free clamp of the portion of the at least one fiber to the substrate.

22. The system of claim 19, wherein the substrate includes at least one adhesion enhancer in the form or a pattern or texture formed in the application area.

23. (canceled)

24. The system of claim 19, wherein the substrate includes a groove formed in the application area to receive the portion of the fiber.

25. The system of claim 24, wherein the groove has a V-shaped cross section or a U-shaped cross section.

26. (canceled)

27. The system of claim 19, wherein the application area is a substantially flat surface or a bowl.

28.-29. (canceled)

30. The system of claim 19, wherein the adhesive is an epoxy adhesive.

31. The system of claim 30, wherein the epoxy is an ultraviolet-cured epoxy.

32.-35. (canceled)

36. The fiber clamp of claim 1, wherein the application area is configured to receive an end or endface of the at least one fiber.

37. The fiber clamp of claim 1, wherein the application area is configured to receive an intermediate portion of the at least one fiber.

38.-64. (canceled)
